(19) United States
(12) Patent Application Publication
(10) Pub. No.: US 2026/0197198 A1
(43) Pub. Date: Jul. 9, 2026

(54) IN-VEHICLE DEVICE, IN-VEHICLE SYSTEM, CONTROL METHOD, AND CONTROL PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Takuya KOBAYASHI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/124,062

(22) PCT Filed: Oct. 12, 2023
(86) PCT No.: PCT/JP2023/037002

§ 371 Date: Apr. 24, 2025

(30) Foreign Application Priority Data
Oct. 28, 2022 (JP) 2022-173011

(51) Int. Cl. H04L 12/40; B60R 16/023; H04L 12/12

(52) U.S. Cl. CPC H04L 12/40039; B60R 16/0231; H04L 12/12

(57) ABSTRACT

An in-vehicle device includes a communication interface, a first determination unit that determines whether a switching condition for switching an operating mode is established, a first switching unit that, if it is determined that the switching condition is established, switches the operating mode from a sleep mode to a low power consumption mode, a second determination unit that determines whether designation information designating the in-vehicle device as a startup target is included in a frame received through a communication line by the communication interface, while the operating mode is the low power consumption mode, and a second switching unit that, if it is determined by the second determination unit that the designation information is included in the received frame, switches the operating mode from the low power consumption mode to a normal mode.

### CROSS-REFERENCE TO RELATED APPLICATIONS

This application is the U.S. national stage of PCT/JP2023/037002 filed on Oct. 12, 2023, which claims priority of Japanese Patent Application No. JP 2022-173011 filed on Oct. 28, 2022, the contents of which are incorporated herein.

### TECHNICAL FIELD

The present disclosure relates to an in-vehicle device, an in-vehicle system, a control method, and a control program.

### BACKGROUND

Vehicles are equipped with a variety of in-vehicle devices, such as control ECUs (Electronic Control Units) that control the engine, transmission and the like, body ECUs that control headlights, power windows and the like, and information ECUs such as navigation devices and multimedia devices. In recent years, in in-vehicle systems in which in-vehicle devices are connected by a bus network, a partial networking function has been developed whereby the in-vehicle devices are divided by function (service) into clusters called PNCs (Partial Network Clusters), and the in-vehicle devices of the PNC to be used in executing a service are woken up, whereas the in-vehicle devices of the other PNCs are put to sleep. The partial networking function is standardized in ISO (International Organization for Standardization) 11898-6.

AUTOSAR Layered Software Architecture, Document ID 53, R21-11, discloses a technology for communication of requests and open information of partial network clusters (PNCs) between ECUs, using network management messages (NM messages).

JP 2015-107672A discloses, as a technology for waking up sleeping ECUs when an anomaly occurs in communication, ECUs that receive a wakeup signal via a communication channel during normal operation, and receive a startup pulse signal addressed thereto from a management ECU via a power supply path when an anomaly occurs in communication.

Each in-vehicle device has a communication interface (hereinafter also referred to as a “communication I/F”) that connects to a communication line (bus). There are communication I/Fs that support the partial networking function (hereinafter also referred to as “supporting I/Fs”) and communication I/Fs that do not support the partial networking function (hereinafter also referred to as “non-supporting I/Fs”).

The supporting I/F wakes up the in-vehicle device, when a frame that designates the PNC to which the in-vehicle device belongs is received. On the other hand, the non-supporting I/F wakes up the in-vehicle device regardless of which PNC is designated, upon receiving a frame broadcast on the communication line. In this way, an in-vehicle device that includes a non-supporting I/F may be woken up and consume power even when the in-vehicle device is not used in the service.

When supporting I/Fs are installed in all of the in-vehicle devices, for example, the introduction cost of the partial networking function increases the greater the number of in-vehicle devices. When ECUs equipped with non-supporting I/Fs are also used in order to reduce the introduction cost of supporting I/Fs, the power consumption of the entire system increases as described above.

### SUMMARY

An in-vehicle device according to one mode of the present disclosure is an in-vehicle device for controlling a control target, including a communication interface that is connected to a communication line, a first determination unit configured to determine whether a switching condition for switching an operating mode of the in-vehicle device from a sleep mode in which control of the control target is not executable to a low power consumption mode in which power consumption in the in-vehicle device is higher than in the sleep mode is established, a first switching unit configured to, if it is determined by the first determination unit that the switching condition is established, switch the operating mode from the sleep mode to the low power consumption mode, a second determination unit configured to determine whether designation information designating the in-vehicle device as a startup target is included in a frame received through the communication line by the communication interface, while the operating mode is the low power consumption mode, and a second switching unit configured to, if it is determined by the second determination unit that the designation information is included in the received frame, switch the operating mode from the low power consumption mode to a normal mode in which power consumption in the in-vehicle device is higher than in the low power consumption mode and control of the control target is executable.

### Advantageous Effects

According to the present disclosure, the partial networking function can be utilized in an in-vehicle device equipped with a communication I/F that does not support the partial networking function.

### BRIEF DESCRIPTION OF DRAWINGS

FIG. 1 is a block diagram showing an example of the configuration of an in-vehicle system according to an embodiment.

FIG. 2 is a block diagram showing an example of the configuration of an integrated ECU having a communication interface that does not support a partial networking function according to the embodiment.

FIG. 3 is a block diagram showing an example of the configuration of an ECU having a communication interface that does not support the partial networking function according to the embodiment.

FIG. 4 is a diagram showing an example of a cluster table.

FIG. 5 is a diagram for describing operating modes of ECUs according to the embodiment.

FIG. 6 is a functional block diagram showing an example of the functions of an ECU having a communication interface that does not support the partial networking function according to the embodiment.

FIG. 7 is a schematic diagram showing a CAN frame format.

FIG. 8 is a diagram showing the link between bits of a data field and clusters.

FIG. 9 is a diagram showing an example of a data field included in an NM frame.

FIG. 10 is a diagram showing examples of transition of the operating mode in an ECU having a communication interface that does not support the partial networking function.

FIG. 11 is a state transition diagram for describing switching of the operating mode of an ECU according to the embodiment.

FIG. 12 is a flowchart showing an example of the operations of an ECU according to the embodiment.

### DETAILED DESCRIPTION OF PREFERRED EMBODIMENTS

Hereinafter, a summary of embodiments of the present disclosure will be enumerated and described.

In a first aspect, an in-vehicle control device according to the present embodiment is an in-vehicle device for controlling a control target, including a communication interface that is connected to a communication line, a first determination unit configured to determine whether a switching condition for switching an operating mode of the in-vehicle device from a sleep mode in which control of the control target is not executable to a low power consumption mode in which power consumption in the in-vehicle device is higher than in the sleep mode is established, a first switching unit configured to, if it is determined by the first determination unit that the switching condition is established, switch the operating mode from the sleep mode to the low power consumption mode, a second determination unit configured to determine whether designation information designating the in-vehicle device as a startup target is included in a frame received through the communication line by the communication interface, while the operating mode is the low power consumption mode, and a second switching unit configured to, if it is determined by the second determination unit that the designation information is included in the received frame, switch the operating mode from the low power consumption mode to a normal mode in which power consumption in the in-vehicle device is higher than in the low power consumption mode and control of the control target is executable. The partial networking function can thereby be utilized in the in-vehicle device, even if the communication interface does not support the partial networking function.

In a second aspect according to the first aspect, the in-vehicle device may further include a third switching unit configured to, if a set period elapses without the communication interface receiving a frame through the communication line, while the operating mode is the low power consumption mode, switch the operating mode from the low power consumption mode to the sleep mode. Power consumption due to continual operation in the low power consumption mode for long periods of time can thereby be suppressed.

In a third aspect according to the second aspect, the set period may be set according to a cluster to which the in-vehicle device belongs. The in-vehicle device is thereby able to wait in the low power consumption mode for reception of a frame containing designation information, for an appropriate period of time that depends on the cluster to which the in-vehicle device belongs.

In a fourth aspect according to the second aspect, the set period may be set according to a state of a vehicle in which the in-vehicle device is installed. The in-vehicle device is thereby able to wait in the low power consumption mode for reception of a frame containing designation information, for an appropriate period of time that depends on the state of the vehicle.

In a fifth aspect according to the second aspect, the set period may be set according to a service that the in-vehicle device provides to a user. The in-vehicle device is thereby able to wait in the low power consumption mode for reception of a frame containing designation information, for an appropriate period of time that depends on the service that the in-vehicle device provides to the user.

In a sixth aspect according to any one of the first to the fifth aspects, the switching condition may be that the communication interface receives a signal. The operating mode of the in-vehicle device can thereby be switched from the sleep mode to the low power consumption mode, in response to a signal being sent by another device in order to provide a service to the user.

In a seventh aspect according to any one of the first to the fifth aspects, the switching condition may be that a preset execution period of the sleep mode ends. The operating mode of the in-vehicle device can thereby be switched from the sleep mode to the low power consumption mode, according to a certain period of time.

In an eighth aspect according to the seventh aspect, the execution period of the sleep mode may be set according to a cluster to which the in-vehicle device belongs. The in-vehicle device is thereby able to wait in the sleep mode, for an appropriate period of time that depends on the cluster to which the in-vehicle device belongs.

In a ninth aspect according to the seventh aspect, the execution period of the sleep mode may be set according to a state of a vehicle in which the in-vehicle device is installed. The in-vehicle device is thereby able to wait in the sleep mode, for an appropriate period of time that depends on the state of the vehicle.

In a tenth aspect according to the seventh aspect, the execution period of the sleep mode may be set according to a service that the in-vehicle device provided to a user. The in-vehicle device is thereby able to wait in the sleep mode, for an appropriate period of time that depends on the service that the in-vehicle device provides to the user.

In an eleventh aspect according to any one of the first to the tenth aspects, the low power consumption mode may be an operating mode in which control of the control target is not executable. Power consumption in the low power consumption mode can thereby be suppressed.

In a twelfth aspect according to any one of the first to the eleventh aspects, the sleep mode may be an operating mode in which processing of a frame received through the communication line is not executable, and the low power consumption mode may be an operating mode in which processing of a frame received through the communication line is executable. Power consumption for processing frames can thereby be suppressed in the sleep mode, and required processing of frames can be executed in the low power consumption mode.

In a thirteenth aspect according to any one of the first to the twelfth aspects, the low power consumption mode may be an operating mode in which an operation clock frequency is lower than in the normal mode. Power consumption in the low power consumption mode can thereby be suppressed.

In a fourteenth aspect according to any one of the first to the thirteenth aspect, the low power consumption mode may be an operating mode in which transmission of a frame by the communication interface is not executable, and the normal mode may be an operating mode in which transmission of a frame by the communication interface is executable. Power consumption for transmission of frames can thereby be suppressed in the low power consumption mode, and required transmission of frames can be executed in the normal mode.

In a fifteenth aspect, an in-vehicle system according to the present embodiment includes the in-vehicle device according to any one of the first to the fourteenth aspects above, the communication line, and an in-vehicle control device connected to the communication line and configured to output the frame to the communication line. The partial networking function can thereby be utilized in the in-vehicle system, even if the communication interface of the in-vehicle device does not support the partial networking function.

In a sixteenth aspect, a control method according to the present embodiment is a control method for use by an in-vehicle device that controls a control target, the control method including a step of determining whether a switching condition for switching an operating mode of the in-vehicle device from a sleep mode in which control of the control target is not executable to a low power consumption mode in which power consumption in the in-vehicle device is higher than in the sleep mode is established, a step of, if it is determined that the switching condition is established, switching the operating mode from the sleep mode to the low power consumption mode, a step of determining whether designation information designating the in-vehicle device as a startup target is included in a frame received through a communication line by a communication interface, while the operating mode is the low power consumption mode, and a step of, if it is determined that the designation information is included in the received frame, switching the operating mode from the low power consumption mode to a normal mode in which power consumption in the in-vehicle device is higher than in the low power consumption mode and control of the control target is executable. The partial networking function can thereby be utilized in the in-vehicle device, even if the communication interface does not support the partial networking function.

In a seventeenth aspect, a control program according to the present embodiment is a control program for use by an in-vehicle device that controls a control target, the control program causing a computer to execute a step of determining whether a switching condition for switching an operating mode of the in-vehicle device from a sleep mode in which control of the control target is not executable to a low power consumption mode in which power consumption in the in-vehicle device is higher than in the sleep mode is established, a step of, if it is determined that the switching condition is established, switching the operating mode from the sleep mode to the low power consumption mode, a step of determining whether designation information designating the in-vehicle device as a startup target is included in a frame received through a communication line by a communication interface, while the operating mode is the low power consumption mode, and a step of, if it is determined that the designation information is included in the received frame, switching the operating mode from the low power consumption mode to a normal mode in which power consumption in the in-vehicle device is higher than in the low power consumption mode and control of the control target is executable. The partial networking function can thereby be utilized in the in-vehicle device, even if the communication interface does not support the partial networking function.

The present disclosure can be realized not only as an in-vehicle device provided with a characteristic configuration such as described above, an in-vehicle system including the in-vehicle control device, and a control method in which the characteristic processing of the in-vehicle device is configured as steps, but is also able to partially or wholly realize the in-vehicle control device as a semiconductor integrated circuit.

Hereinafter, embodiments of the present disclosure will be described in detail, with reference to the drawings. Note that at least some of the embodiments described below may be combined in any suitable manner.

### In-Vehicle System

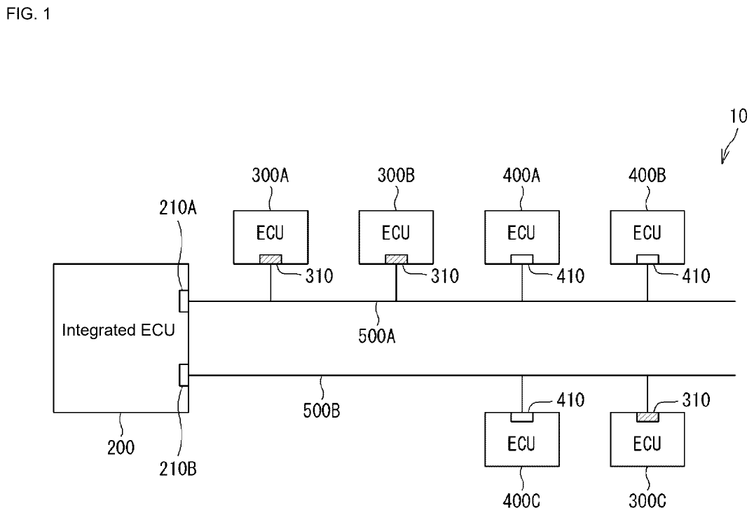

FIG. 1 is a block diagram showing an example of the configuration of an in-vehicle system according to the present embodiment. The in-vehicle system 10 is installed in a vehicle.

The in-vehicle system 10 according to the present embodiment includes an integrated ECU 200 and ECUs 300A, 300B, 300C, 400A, 400B, and 400C. The in-vehicle system 10 is an in-vehicle network constituted by the integrated ECU 200, the ECUs 300A, 300B, 300C, 400A, 400B, and 400C, and communication cables (communication buses) connecting the ECUs to each other.

The plurality of ECUs 300A, 300B, 300C, 400A, 400B, and 400C are disposed in various parts of the vehicle. The ECUs 300A, 300B, 300C, 400A, 400B, and 400C perform processing such as individually controlling the hardware of the various parts of the vehicle and monitoring the state of the hardware of the various parts of the vehicle. For example, the ECUs 300A, 300B, 300C, 400A, 400B, and 400C are control ECUs, body ECUs, and information ECUs. Note that, in the following description, the ECUs 300A, 300B, and 300C will also be collectively referred to as the “ECUs 300”, and the ECUs 400A, 400B, and 400C will also be collectively referred to as the “ECUs 400”.

The integrated ECU 200 is connected to the ECUs 300A, 300B, 300C, 400A, 400B, and 400C via in-vehicle buses 500A and 500B such as CAN (Controller Area Network) buses. Specifically, the integrated ECU 200 is provided with communication interfaces (communication I/Fs) 210A and 210B. The communication I/F 210A is connected to the in-vehicle bus 500A. The ECUs 300A, 300B, 400A, and 400B are connected to the in-vehicle bus 500A. The communication I/F 210B is connected to the in-vehicle bus 500B. The ECUs 300C and 400C are connected to the in-vehicle bus 500B. The integrated ECU 200 is able to communicate mutually with each of the ECUs 300A, 300B, 300C, 400A, 400B, and 400C. Hereinafter, the integrated ECU 200 may be referred to as “ECU 200”.

The ECUs 300A, 300B, and 300C are each provided with a communication I/F 310 connected to an in-vehicle bus. The ECUs 400A, 400B, and 400C are each provided with a communication I/F 410 connected to an in-vehicle bus.

In FIG. 1, the communication I/Fs 310, which are shown with oblique hatching, are supporting I/Fs that support the partial networking function, and the communication I/Fs 210A, 210B, and 410, which are shown without hatching, are non-supporting I/Fs that do not support the partial networking function. That is, in the in-vehicle system 10, the ECUs 300 having supporting I/Fs exist together with the ECU 200 and ECUs 400 having non supporting I/Fs. The ECU 200 and ECUs 400 are examples of the “in-vehicle device”.

The ECUs 200, 300, and 400 use a communication protocol that supports the partial networking function. The communication protocol is, for example, CAN, CAN FD (CAN with Flexible Data Rate), or CAN PN (CAN with Partial Networking).

The integrated ECU 200 functions as a gateway that relays communication between the ECUs 300A, 300B, 300C, 400A, 400B, and 400C. The ECUs 300 and 400 are able to transmit frames. An example of a frame is an NM (Network Management) frame for network management. The integrated ECU 200 relays frames between the ECUs connected to different buses. For example, the integrated ECU 200 is able to relay frames between the ECU 300A connected to the in-vehicle bus 500A and the ECU 400C connected to the in-vehicle bus 500B. For example, frames can thereby be transmitted and received between the ECUs 300A, 300B, 400A, and 400B connected to the in-vehicle bus 500A and the ECUs 300C and 400C connected to the in-vehicle bus 500B.

### Configuration of Integrated ECU

In the present embodiment, the partial networking function is utilizable in the integrated ECU 200 and the ECUs 400 having non supporting I/Fs. Hereinafter, the hardware configuration of the integrated ECU 200 will be described.

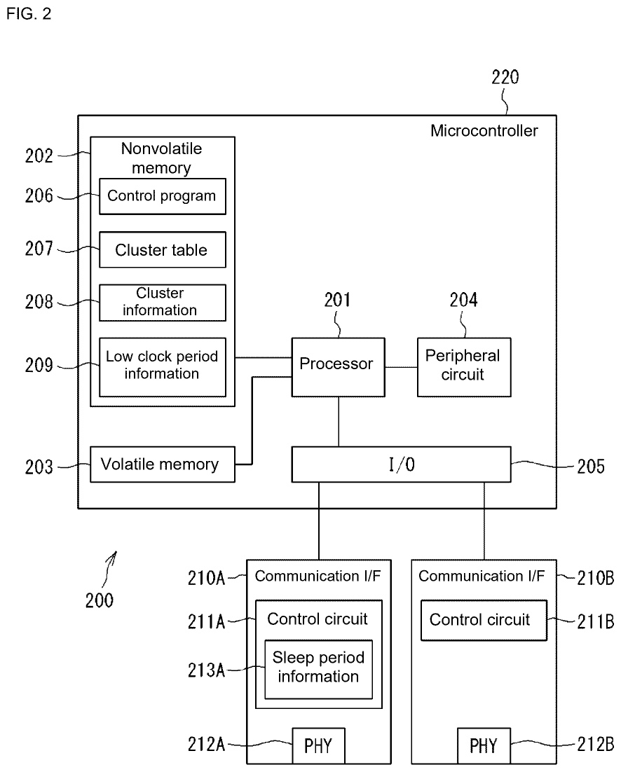

FIG. 2 is a block diagram showing an example of the configuration of an integrated ECU having a non-supporting I/F according to the present embodiment. The integrated ECU 200 includes a microcontroller 220 and the communication I/Fs 210A and 210B.

The microcontroller 220 is, for example, a single chip semiconductor integrated circuit, and includes a processor 201, a nonvolatile memory 202, a volatile memory 203, a peripheral circuit 204, and an input/output interface (I/O) 205.

The volatile memory 203 is, for example, a semiconductor memory such as a SRAM (Static Random Access Memory) or a DRAM (Dynamic Random Access Memory). The nonvolatile memory 202 is, for example, a semiconductor memory such as a flash memory, a ROM (Read-Only Memory), an EPROM (Erasable Programmable Read-Only Memory), or an EEPROM (Electrically Erasable Programmable Read-Only Memory).

The processor 201 is, for example, a CPU (Central Processing Unit). The processor 201 is, however, not limited to a CPU. The processor 201 may also be a GPU (Graphics Processing Unit). The processor 201 is configured to execute computer programs. Note that the processor 201 may include an ASIC (Application Specific Integrated Circuit) in part thereof, or a programmable logic device such as an FPGA (Field Programmable Gate Array) in part thereof, for example.

The nonvolatile memory 202 stores a control program 206, which is a computer program, and data that is used in execution of the control program 206. The control program 206 can be stored in a recording medium such as a flash memory, a ROM, or a CD-ROM. The processor 201 enables the partial networking function to be utilized in the integrated ECU 200, with the control program 206.

The nonvolatile memory 202 stores a cluster table 207, cluster information 208, and low clock period information 209. The cluster table 207, the cluster information 208, and the low clock period information 209 will be described later.

The peripheral circuit 204 is a circuit for realizing various functions in the microcontroller 220. For example, the peripheral circuit 204 includes a general-purpose input/output port (GPIO), an analog/digital converter, a timer, and a circuit such as a serial communication circuit. The serial communication circuit conforms to a standard such as UART (Universal Asynchronous Receiver/Transmitter), I2C (Inter-Integrated Circuit), or SPI (Serial Peripheral Interface), for example.

The I/O 205 is connected to the communication I/Fs 210A and 210B. The I/O 205 is a port that is used in performing input and output with the communication I/Fs 210A and 210B.

The communication I/Fs 210A and 210B are communication interfaces that conform to a communication protocol for an in-vehicle network such as described above. As described above, the communication I/Fs 210A and 210B are non-supporting I/Fs that do not support the partial networking function.

The communication I/F 210A includes a control circuit 211A and a PHY 212A. The control circuit 211A is a circuit for executing processing of frames to be transmitted and frames that have been received. The control circuit 211A has a memory storing sleep period information 213A. The control circuit 211A is capable of executing a timer function that uses the sleep period information 213A. The sleep period information 213A will be described later.

The PHY 212A is connected to the in-vehicle bus 500A, and converts analog signals to digital signals on the in-vehicle bus 500Aside and digital signals to analog signals on the control circuit 211A side. The PHY 212A does not support the partial networking function and is not able to interpret the PNCs designated as the wakeup target in the frames.

The communication I/F 210B includes a control circuit 211B and a PHY 212B. The control circuit 211B has a similar configuration to the control circuit 211A. Since the control circuit 211A is, however, capable of executing a timer function that uses the sleep period information 213A, the control circuit 211B need not execute a similar timer function. In other words, the control circuit 211B need not store the sleep period information.

The PHY 212B is connected to an in-vehicle bus 500B, and converts analog signals to digital signals on the in-vehicle bus 500B side, and digital signals to digital signals on the control circuit 211B side. Similarly to the PHY 212A, the PHY 212B does not support the partial networking function.

### Configuration of Ecus

Hereinafter, the hardware configuration of the ECU 400 which does not support the partial networking function will be described.

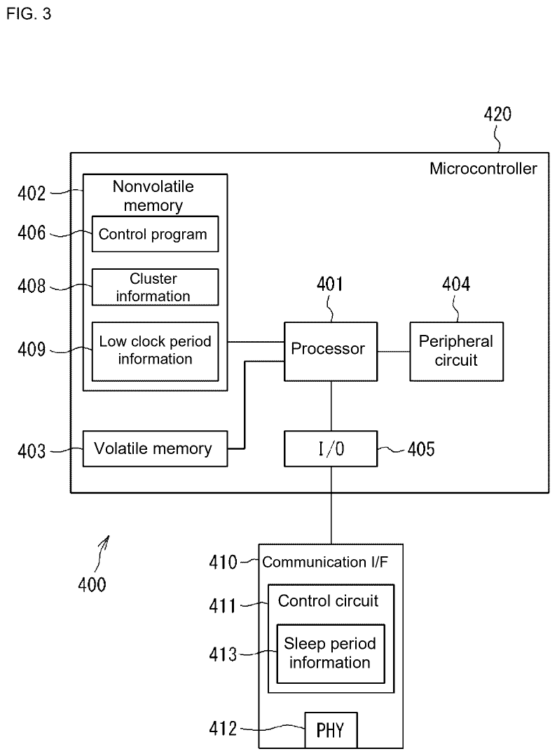

FIG. 3 is a block diagram showing an example of the configuration of an ECU having a non-supporting I/F according to the present embodiment. The ECU 400 includes a microcontroller 420 and a communication I/F 410.

The microcontroller 420 has the same configuration as the microcontroller 220 of the integrated ECU 200 described above. In other words, the microcontroller 420 includes a processor 401, a nonvolatile memory 402, a volatile memory 403, a peripheral circuit 404, and an I/O 405.

The nonvolatile memory 402 stores a control program 406, which is computer program, and data that is used in execution of the control program 406. The control program 406 can be stored in a recording medium such as a flash memory, a ROM, or a CD-ROM. The processor 401 enables the partial networking function to be utilized in the ECU 400, with the control program 406.

The nonvolatile memory 402 stores cluster information 408 and low clock period information 409. The cluster information 408 and the low clock period information 409 will be described later.

The peripheral circuit 404 includes a serial communication circuit that conforms to a standard such as UART, I2C, or SPI, for example. The serial communication circuit of the peripheral circuit 404 is connected to a sensor or a device serving as the control target of the ECU 400, and is able to perform processing such as receiving signals output from the sensor or transmitting control signals to the control target.

The I/O 405 is connected to the communication I/F 410. The I/O 405 is a port that is used in performing input and output with the communication I/F 410.

The communication I/F 410 is a communication interface that conforms to a communication protocol for an in-vehicle network such as described above. As described above, the communication I/F 410 is a non-supporting I/F that does not support the partial networking function.

The communication I/F 410 includes a control circuit 411 and a PHY 412. The control circuit 411 is a circuit for executing processing of frames to be transmitted and frames that have been received. The control circuit 411 has a memory storing sleep period information 413. The control circuit 411 is capable of executing a timer function that uses the sleep period information 413. The sleep period information 413 will be described later.

The PHY 412 is connected to the in-vehicle bus 500A or bus 500B, and converts analog signals to digital signals on the in-vehicle bus side and digital signals to analog signals on the control circuit 411 side. The PHY 412 does not support the partial networking function and is not able to interpret the PNCs designated as the wakeup target in the frames.

### Clusters

Clusters will now be described. The ECUs 200, 300, and 400 each belong to at least one cluster. The nonvolatile memory 202 of the integrated ECU 200 stores the cluster table 207 that links the ECUs 200, 300, and 400 to the clusters to which the ECUs 200, 300 and 400 respectively belong (see FIG. 2).

A cluster may be set for each service that is provided to the user, for example. A service is executed by one or more of the ECUs 200, 300, and 400.

Examples of services that are executed by a plurality of ECUs include auto high beam control of headlights, auto cruise, door unlocking, remote control of the air conditioner, anti-theft alarm notification, charging of a drive battery (high-voltage battery) in an electric vehicle, and charging of an auxiliary battery (low-voltage battery) from the drive battery.

Auto high beam control of the headlights is executed by a headlight ECU that controls the headlights and vehicle drive ECUs (engine ECU, brake ECU, etc.). The headlight ECU and the vehicle drive ECUs thus belong to the same cluster.

Auto cruise is executed by an ADAS (Advanced Driver-Assistance Systems) ECU, a radar ECU that processes radar detection results and detects objects outside the vehicle, and vehicle drive ECUs. The ADAS ECU, the radar ECU, and the vehicle drive ECUs thus belong to the same cluster.

Door unlocking is executed by body ECUs that control moving parts (door locks, power windows, door mirrors, etc.) of the vehicle body and an authentication ECU that authenticates code transmitted from a smart key (key fob), for example. The body ECUs and the authentication ECU thus belong to the same cluster.

Remote control of the air conditioner is executed by an air conditioner ECU that controls the air conditioner and the engine ECU that controls the engine, for example. The air conditioner ECU and the engine ECU thus belong to the same cluster.

Anti-theft alarm notification is executed by, for example, an alarm ECU that issues an alarm and an external communication ECU that communicates with devices outside the vehicle (e.g., server of security company). The alarm ECU and the external communication ECU thus belong to the same cluster.

Charging of the drive battery is executed by, for example, a charging ECU that controls charging of the drive battery and the auxiliary battery, and a battery management ECU that manages the drive battery. The charging ECU and the battery management ECU thus belong to the same cluster.

Charging of the auxiliary battery is executed by the charging ECU, the battery management ECU, and a power conversion ECU for controlling a DC/DC converter that converts the DC voltage output from the drive battery. The charging ECU, the battery management ECU, and the power conversion ECU thus belong to the same cluster.

There are also services that are executed by a single ECU. Accordingly, clusters that include only one ECU can also be set. Examples of services that are executed by a single ECU include wiper drive, automatic steering adjustment, and automatic seat adjustment.

Wiper drive is executed by a wiper ECU that controls the wipers. Only the wiper ECU thus belongs to the cluster.

Automatic steering adjustment is executed by a power steering ECU that controls the power steering. Only the power steering ECU thus belongs to the cluster.

Automatic seat adjustment is executed by a seat ECU that controls the power seats. Only the seat ECU thus belongs to the cluster.

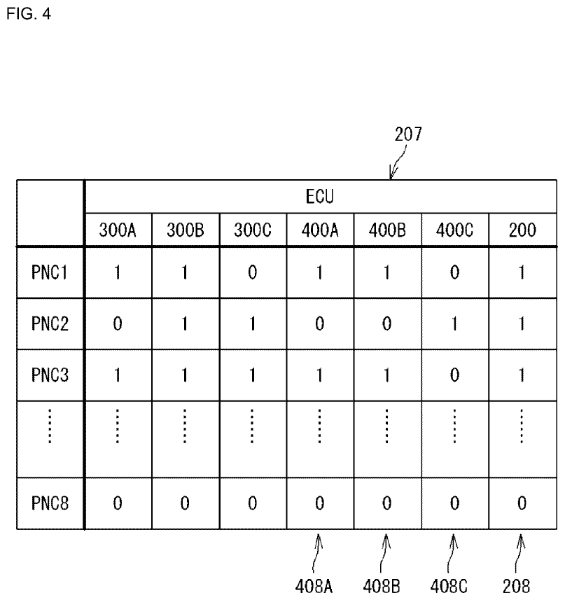

FIG. 4 is a diagram showing an example of the cluster table. The cluster table 207 in FIG. 4 shows which of the eight clusters PNC1 to PNC8 the ECUs 200, 300, and 400 respectively belong to. Note that the number of clusters in FIG. 4 is an example, and nine or more clusters may be provided. Fewer than eight clusters may be also provided. In the table, “1” indicates that the ECUs 200, 300, and 400 respectively belong to the cluster of that row, and “0” indicates that the ECUs 200, 300, and 400 respectively do not belong to the cluster of that row.

For example, the ECUs 300A, 300B, 400A, 400B, and 200 belong to the cluster PNC1. The ECUs 300B, 300C, 400C, and 200 belong to the cluster PNC2. The ECUs 300A, 300B, 300C, 400A, 400B, and 200 belong to the cluster PNC3. None of the ECUs 200, 300, and 400 belong to the cluster PNC8, which is a so-called “empty” cluster. In the following description, “Wake up ECUs 300A, 300B, 400A, 400B, 200 belonging to cluster PNC1” is also expressed simply as “wake up cluster PNC1”. Similar expressions are used for the other clusters PNC2 to PNC8.

### Operating Modes

Prior to describing the operating modes of the ECU 200 and ECUs 400 that do not support the partial networking function, the operating modes and wakeup operation of the ECU 300 that supports the partial networking function will be described.

The operating modes of the ECU 300 include a normal mode and a sleep mode. In the normal mode, the ECU 300 is operating, and is capable of controlling the control target and communicating with the other ECUs 200, 300, and 400. The sleep mode is a state in which the ECU 300 stops operating, except for some functions of the communication I/F 310.

With CAN, in the case of waking up some of the clusters with the partial networking function, a frame (management control frame; hereinafter, also referred to as “NM frame”) designating the clusters to be woken up is transmitted on the in-vehicle buses 500A and 500B. A wakeup request, that is, an NM frame designating the clusters to be woken up is transmitted by the integrated ECU 200, for example. In the case of the integrated ECU 200, the NM frame is created using the cluster table 207. The transmission source of the NM frame is, however, not limited to the integrated ECU 200, and the ECUs 300 and 400 may also transmit the NM frame.

The communication I/F 310 of the ECU 300 in the sleep mode receive the NM frame and determine whether the cluster to which the ECU 300 belongs is designated in the NM frame. When the cluster to which the ECU 300 belongs is not designated, the ECU 300 maintains the sleep mode. When the cluster to which the ECU 300 belongs is designated, the communication I/F 310 interrupt the processor and instruct the processor to switch from the sleep mode to the normal mode. The ECU 300 belonging to the designated cluster thereby wakes up.

Next, the operating modes of the ECU 200 and ECUs 400 that do not support the partial networking function will be described.

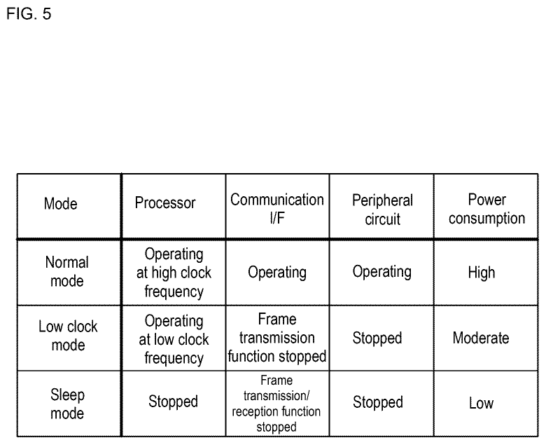

The operating modes of the ECU 200 and ECUs 400 include a normal mode, a low clock mode, and a sleep mode. FIG. 5 is a diagram for describing the operating modes of the ECUs according to the embodiment.

Specifically, the operating modes of the ECU 200 and ECUs 400 are the operating modes of the microcontrollers 220 and 420. The operating states of the processors 201 and 401, the operating states of the communication I/Fs 210A, 210B, and 410, and the operating states of the peripheral circuits 204 and 404 differ depending on the operating mode.

In the normal mode, the processors 201 and 401 operate at a high clock frequency. In the low clock mode, the processors 201 and 401 operate at a low clock frequency (i.e., a clock frequency lower than in the normal mode). In the sleep mode, the processors 201 and 401 stop operating.

In the normal mode, the communication I/Fs 210A, 210B, and 410 are operating. The communication I/Fs 210A, 210B, and 410 are also operating in the low clock mode, except for the frame transmission function. In other words, in the normal mode, the communication I/Fs 210A, 210B, and 410 are capable of performing processing including transmission and reception of frames. In the low clock mode, the communication I/Fs 210A, 210B, and 410 are capable of performing processing including reception of frames, but are not capable of transmission of frames. In the sleep mode, the communication I/Fs 210A, 210B, and 410 stop some functions. Specifically, in the sleep mode, the communication I/Fs 210A, 210B, and 410 execute the timer function and a dominant state detection function described later, and stop other functions. In other words, in the sleep mode, the communication I/Fs 210A, 210B, and 410 are not capable of processing including transmission and reception of frames.

In the normal mode, the peripheral circuits 204 and 404 are operating. In other words, in the normal mode, the ECU 200 and ECUs 400 are able to perform processing such as receiving signals output from sensors and controlling control targets. In the low clock mode, the peripheral circuits 204 and 404 stop operating. The peripheral circuits 204 and 404 also stop operating in the sleep mode. In other words, in the low clock mode and the sleep mode, the ECU 200 and ECUs 400 are not able to perform processing such as receiving signals output from sensors and controlling control targets.

In a normal mode such as described above, power consumption by the ECU 200 and ECUs 400 is high. In the sleep mode, power consumption by the ECU 200 and ECUs 400 is low. Power consumption by the ECU 200 and ECUs 400 in the low clock mode is less than power consumption in the normal mode and greater than power consumption in the sleep mode.

### Functions of Ecus

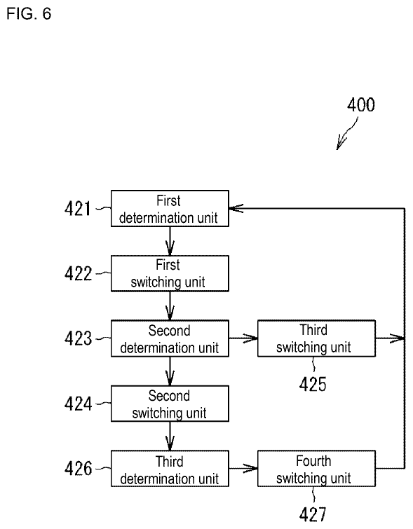

FIG. 6 is a functional block diagram showing an example of the functions of an ECU having a non-supporting I/F according to the present embodiment. Here, the functions of the ECU 400 will be representatively described, but the integrated ECU 200 also has similar functions.

The ECU 400 has, as functions, a first determination unit 421, a first switching unit 422, a second determination unit 423, a second switching unit 424, a third switching unit 425, a third determination unit 426, and a fourth switching unit 427. The first determination unit 421 and the first switching unit 422 are functions of the control circuit 411. The second determination unit 423, the second switching unit 424, the third switching unit 425, the third determination unit 426, and the fourth switching unit 427 are functions of the processor 401. The functions of the second determination unit 423, the second switching unit 424, the third switching unit 425, the third determination unit 426, and the fourth switching unit 427 are realized by the processor 401 executing the control program 406.

The first determination unit 421 determines whether a switching condition for switching the operating mode of the ECU 400 from the sleep mode to the low power consumption mode is established.

An example of the switching condition is the communication I/F 410 receiving a signal.

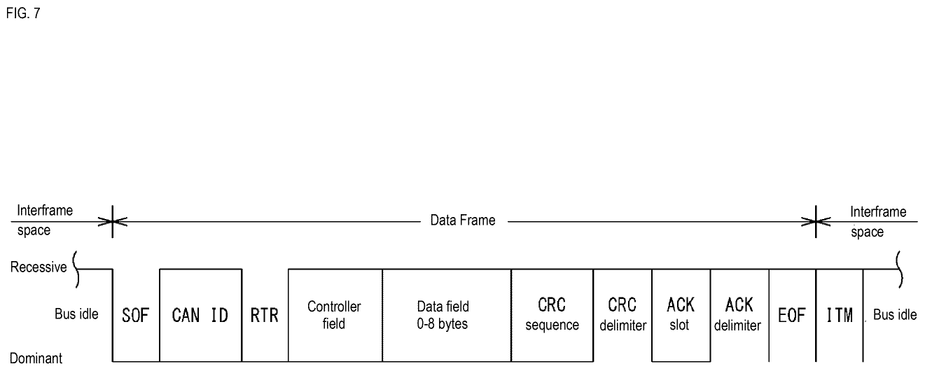

FIG. 7 is a schematic diagram showing a CAN frame format. FIG. 7 shows the data frame structure of a standard CAN format. The upper line in the figure shows the recessive state, and the lower line shows the dominant state. As shown in FIG. 7, a CAN data frame includes the following fields: SOF (Start Of Frame), CAN ID, RTR (Remote Transmission Request), control field, data field, CRC (Cyclic Redundancy Check) sequence, CRC delimiter, ACK (Acknowledgement) slot, ACK delimiter, and EOF (End Of Frame). SOF indicates the start of the frame. The CAN ID is used for identifying the type of ECU and frame. The RTR is used for identifying a data frame and a remote frame. In the case of a data frame, the RTR is dominant. The control field stores information that is used in communication control. The data field stores a maximum of 8 bytes of actual data (payload). The CRC sequence and the CRC delimiter are collectively referred to as a CRC field, and a type of error detection code is stored in the CRC field. The ACK slot and the ACK delimiter are collectively referred to as an ACK field, and information indicating whether the portion up to and including the CRC field has been received normally is stored in the ACK field. EOF indicates the end of the frame.

The frame starts with the dominant state. A specific example of a switching condition is the communication I/F 410 detecting the dominant state. The first determination unit 421 functions in the sleep mode. As described above, in the sleep mode, the communication I/F 410 is not capable of receiving frames, but is capable of executing dominant state detection. When another ECU transmits a frame, the communication I/F 410 detects the dominant state at the head of the frame. The first determination unit 421 determines whether the dominant state has been detected by the communication I/F 410.

Another example of a switching condition is the sleep period ending. The sleep period is the execution period of the sleep mode. As shown in FIG. 3, the control circuit 411 stores the sleep period information 413. The sleep period information is information indicating the sleep period.

As one example, the sleep period is set according to the cluster to which the ECU 400 belongs. For example, in PNC1, the sleep period is set to a first period, and, in PNC2, the sleep period is set to a second period that differs from the first period. In this way, the sleep period can be set for each cluster.

In another example, the sleep period is set according to the state of the vehicle in which the ECU 400 is installed. For example, the vehicle states include an IG (ignition) ON state, an ACC (accessory) state, a driving state, a state in which the vehicle is stopped with no occupants (hereinafter also referred to as a “stopped state without occupants”), a state in which the vehicle is stopped with one or more occupants (hereinafter also referred to as a “stopped state with occupants”), and a charging state in which the drive battery of the electric vehicle is being charged. In this way, the sleep period can be set for each vehicle state.

In a further example, the sleep period is set according to the service that the ECU 400 provides to the user. In the case where the ECU 400 is a headlight ECU that provides auto high beam control of the headlights, for example, a sleep period that corresponds to the auto high beam control is set. In the case where the ECU 400 is a body ECU that provides door unlocking, for example, a sleep period that corresponds to the door unlocking is set.

The services include immediacy services that require immediacy and non-immediacy services that do not require immediacy. An immediacy service is a service that needs to be executed immediately after execution of the service is requested. Specifically, an immediacy service is a service whose allowable time from reception of the frame requesting execution of the service by the ECU to execution of processing for the service in the ECU is less than a reference value. A non-immediacy service is a service that does not need to be executed immediately after execution of the service is requested. Specifically, a non-immediacy service is a service whose allowable time from reception of the frame requesting execution of the service by the ECU to execution of processing for the service in the ECU is greater than or equal to the reference value.

When the ECU 400 has been in the sleep mode for a long period of time in the case where the service that is provided is an immediacy service, the ECU 400 could possibly be unable to immediately execute the service. Thus, when the service that the ECU 400 provides is an immediacy service, the sleep period is set to a short period of time. In contrast, when the service that the ECU 400 provides is a non-immediacy service, the sleep period is set longer than the sleep period of an ECU that provides an immediacy service.

As described above, a cluster can be set for each service. The wiper drive, for example, is an immediacy service. A short sleep period is thus set for the wiper ECU belonging to the cluster corresponding to the wiper drive. Other examples of immediacy services are auto high beam control of the headlights, auto cruise, door unlocking, automatic steering adjustment, and automatic seat adjustment. ECUs belonging to the clusters corresponding to these services are set to a short sleep period (e.g., sleep period less than a predetermined reference value). Note that the same sleep period may be set for all of the immediacy services, or different sleep periods may be set depending on the immediacy service.

For example, remote control of the air conditioner is a non-immediacy service. A long sleep period is thus set for the air conditioner ECU and the engine ECU belonging to the cluster corresponding to remote control of the air conditioner. Other examples of non-immediacy services are anti-theft alarm notification, charging of the drive battery of the electric vehicle, and charging the auxiliary battery from the drive battery. The ECUs belonging to the clusters corresponding to these services are set to a long sleep period (e.g., sleep period greater than or equal to the predetermined reference value). Note that the same sleep period may be set for all non-immediacy services, or different sleep periods may be set depending on the non-immediacy service.

Services can be classified by vehicle state. Services corresponding to the IG ON state are wiper drive and auto high beam control of the headlights, for example. A service corresponding to the driving state is auto cruise, for example. Services corresponding to the stopped state with occupants are door unlocking, automatic steering adjustment, and automatic seat adjustment, for example. Services corresponding to the stopped state without occupants include remote control of the air conditioner and anti-theft alarm notification. Services corresponding to the charging state of the electric vehicle include charging of the drive battery and charging of the auxiliary battery from the drive battery.

In the IG ON state, the driving state, and the stopped state with occupants, immediate execution of the services is required. That is, the services respectively corresponding to the IG ON state, the driving state, and the stopped state with occupants are immediacy services. A short sleep period is thus set for the ECUs that execute the services respectively corresponding to the IG ON state, the driving state, and the stopped state with occupants.

In the stopped state without occupants and the charging state, immediate provision of the services is not necessarily required. That is, the services respectively corresponding to the stopped state without occupants and the charging state are non-immediacy services. Along sleep period is thus set for the ECUs that execute the services respectively corresponding to the stopped state without occupants and the charging state.

Note that a common sleep period may be set for all of the ECU 200 and ECUs 400.

Returning to FIG. 6, switching conditions may include both the communication I/F 410 detecting the dominant state and the sleep period ending. That is, the first determination unit 421 may determine that a switching condition is established, when the communication I/F 410 detects the dominant state or when the sleep period ends.

If it is determined by the first determination unit 421 that a switching condition is established, the first switching unit 422 switches the operating mode of the ECU 400 from the sleep mode to the low clock mode. Specifically, when a switching condition is established, the first switching unit 422 interrupts the processor 401 and instructs the processor 401 to transition to the low clock mode. The operating mode of the ECU 400 (microcontroller 420) thereby switches from the sleep mode to the low clock mode.

In the low clock mode, the processor 401 operates at a low clock frequency. The second determination unit 423, which is a function of the processor 401, determines whether designation information designating the ECU 400 as a startup target is included in the frame (NM frame) received by the communication I/F 410 through the in-vehicle bus 500, while the operating mode of the ECU 400 is the low clock mode. Note that “startup” here refers to the ECU 400 starting operation in the normal mode and includes “wakeup”.

As described above, the cluster to be woken up is designated in the NM frame. The designation information is information that designates the cluster to be woken up. In a specific example, the NM frame includes a data field F1 that designates the cluster to be woken up among the plurality of clusters PNC1 to PNC8.

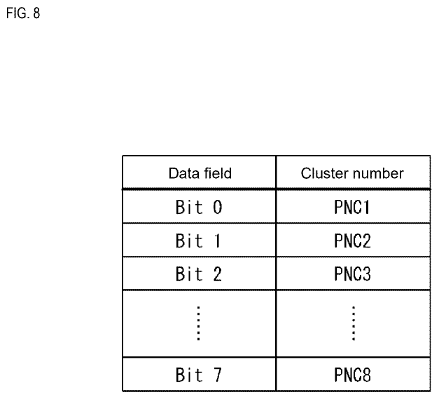

FIG. 8 is a diagram showing the link between the bits of the data field F1 and the clusters PNC1 to PNC8. The data field F1 is constituted by, for example, 8 bits, and the clusters PNC1 to PNC8 are each assigned to a different bit. For example, the cluster PNC1 is assigned to the first bit (Bit 0).

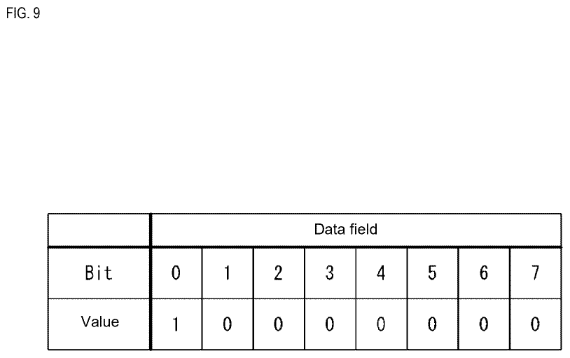

FIG. 9 is a diagram showing an example of the data field F1 included in the NM frame. Each bit in the data field F1 is a flag indicating whether the corresponding cluster is the wakeup target. If the corresponding cluster is not the wakeup target, the bit is set to “0”. If the corresponding cluster is the wakeup target, the bit is set to “1”. For example, in the data field F1 in FIG. 9, Bit 0 is “1” and Bits 1 to 7 are “0”. In other words, the cluster PNC1 is designated as the wakeup target.

Hereinafter, in the data field F1 of the NM frame, setting a bit to “1” will be appropriately expressed as “enabling” the cluster corresponding to that bit, and setting a bit to “0” will be appropriately expressed as “disabling” the cluster corresponding to that bit.

The ECU 200 and ECUs 400 respectively store the cluster information 208 and 408 in the nonvolatile memories 202 and 402 (see FIGS. 2 and 3). The cluster information 208 and 408 is information indicating the clusters to which the ECU belongs. For example, in the case of the ECU 400A, the same information as the fourth column from the left (column showing the clusters to which the ECU 400A belongs) in the cluster table 207 shown in FIG. 4 is stored in the nonvolatile memory 402 as the cluster information 408. In the case of the ECU 400B, the same information as the fifth column from the left in the cluster table 207 is stored in the nonvolatile memory 402 as the cluster information 408.

Returning to FIG. 6, when the ECU 400 in the low clock mode receives an NM frame including the data field F1 via the in-vehicle bus 500, the second determination unit 423 determines whether the cluster information 408 stored in the nonvolatile memory 402 matches the data field F1. Specifically, the second determination unit 423 calculates the product of each bit of the cluster information 408 and the corresponding bit in the data field F1. If there is a bit whose calculated product is “1”, it is determined that the cluster information 408 and the data field F1 “match”, that is, that designation information designating the ECU 400 as a startup target is included in the NM frame.

In the examples of FIGS. 4, 8, and 9, the cluster information 408 has an 8-bit pattern “101 . . . 0”, and the data field F1 has an 8-bit pattern “100 . . . 0”. According to FIG. 8, the nth bit of the cluster information 408 corresponds to the nth bit of the data field F1. In this example, the product of the first bit of the cluster information 408 and the first bit of the data field F1 is “1”, and thus the NM frame includes designation information designating the ECU 400A as a startup target.

Returning to FIG. 6, when it is determined by the second determination unit 423 that designation information designating the ECU 400 as a wakeup target is included in the NM frame, the second switching unit 424 switches the operating mode of the ECU 400 (microcontroller 420) from the low clock mode to the normal mode.

When the low clock period elapses without the communication I/F 410 receiving a frame through the in-vehicle bus 500, while the operating mode of the ECU 400 is the low clock mode, the third switching unit 425 switches the operating mode of the ECU 400 from the low clock mode to the sleep mode. The low clock period is an example of the “set period”.

The low clock period is the shortest execution period of the low clock mode. In other words, when the low clock period elapses without a frame being received after the operating mode of the ECU 400 switches to the low clock mode, the operating mode of the ECU 400 switches from the low clock mode to the sleep mode. When the ECU 400 receives a frame while in the low clock mode, the low clock period is reset. In this case, the operating mode transitions to the sleep mode, after the low clock period elapses from when the ECU 400 last received a frame.

As shown in FIG. 3, the nonvolatile memory 402 stores the low clock period information 409. The low clock period information 409 is information indicating the low clock period.

In one example, the low clock period is set according to the cluster to which the ECU 400 belongs. For example, in PNC1, the low clock period is set to a third period, and, in PNC2, the low clock period is set to a fourth period that differs from the third period. In this way, a low clock period can be set for each cluster.

In another example, the low clock period is set according to the state of the vehicle in which the ECU 400 is installed (IG ON state, ACC state, driving state, stopped state without occupants, stopped state with occupants, charging state, etc.).

In a further example, the low clock period is set according to the service that the ECU 400 provides to the user. When the ECU 400 is a headlight ECU, for example, a low clock period that corresponds to auto high beam control is set. When the ECU 400 is a body ECU, for example, a low clock period that corresponds to door unlocking is set.

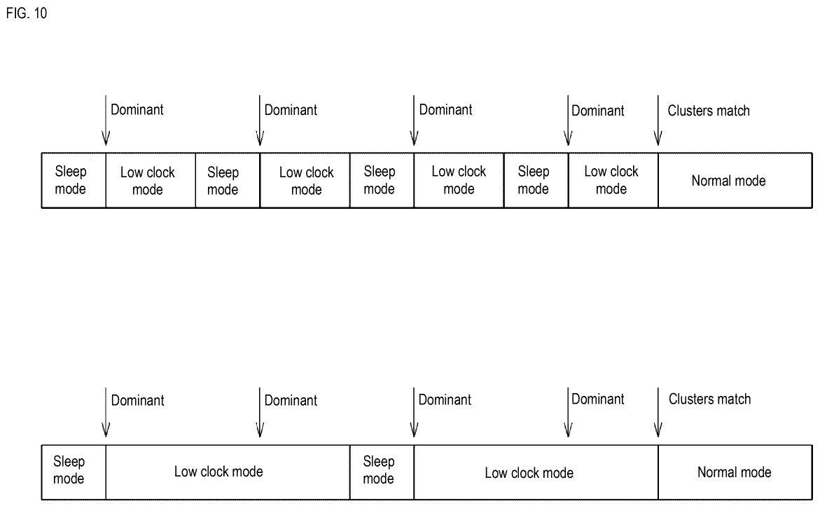

FIG. 10 is a diagram showing an example of transition of the operating mode in the ECU 400 having the non-supporting I/F 410. In the upper example, the low clock mode is a short period. In the lower example, the low clock mode is a long period. When the dominant state is detected in the case where the operating mode of the ECU 400 is the sleep mode, the operating mode switches from the sleep mode to the low clock mode. When the low clock mode ends, the operating mode switches from the low clock mode to the sleep mode. In the upper example in which the low clock period is short, the operating mode switches frequently. The total duration of the sleep mode thus increases, and power consumption can be suppressed. On the other hand, in the lower example in which the low clock period is long, the duration of the low clock mode occupies a high proportion of the entire period. Accordingly, the operating mode can be switched to the normal mode immediately upon wakeup being instructed in the NM frame.

When the ECU 400 frequently switches to the sleep mode in the case where the service that is provided is an immediacy service, the ECU 400 could possibly be unable to immediately execute the service. Thus, when the service that the ECU 400 provides is an immediacy service, the low clock period is set to a long period (lower example in FIG. 10). In contrast, when the service that the ECU 400 provides is a non-immediacy service, the low clock period is set shorter than the low clock period of an ECU that provides an immediacy service (upper example in FIG. 10). The operating mode switches to the sleep mode when the short low clock period ends, thereby enabling power consumption to be suppressed.

As described above, a cluster can be set for each service. For example, a wiper ECU belonging to the cluster corresponding to wiper drive, which is an immediacy service, is set to a long low clock period. As mentioned above, examples of immediacy services include auto high beam control of headlights, auto cruise, door unlocking, automatic steering adjustment, and automatic seat adjustment. The ECUs 400 belonging to the clusters corresponding to these services are set to a long low clock period (e.g., a low clock period greater than or equal to a predetermined reference value). Note that the same low clock period may be set for all of the immediacy services, or different low clock periods may be set depending on the immediacy service.

For example, a short low clock period is set for the air conditioner ECU and the engine ECU belonging to the cluster corresponding to remote control of the air conditioner, which is a non-immediacy service. As described above, examples of non-immediacy services include anti-theft alarm notification, charging of the drive battery of the electric vehicle, and charging the auxiliary battery from the drive battery. The ECUs belonging to clusters corresponding to these services are set to a short low clock period (e.g., a low clock period less than the predetermined reference value). Note that the same low clock period may be set for all non-immediacy services, or different low clock periods may be set depending on the non-immediacy service.

Services can be classified by vehicle state. A long low clock period is set for the ECUs that execute the services respectively corresponding to the IG ON state, the driving state, and the stopped state with occupants, which are immediacy services.

A short low clock period is set for the ECUs that execute the services respectively corresponding to the stopped state without occupants and the charging state, which are non-immediacy services.

Note that a common low clock period may be set for all of the ECU 200 and ECUs 400.

Returning to FIG. 6, the third determination unit 426 determines whether a sleep condition set in advance is established, while the operating mode of the ECU 400 is the normal mode. Sleep conditions are set for each ECU.

If it is determined by the third determination unit 426 that a sleep condition is established, the fourth switching unit 427 switches the operating mode of the ECU 400 from the normal mode to the sleep mode.

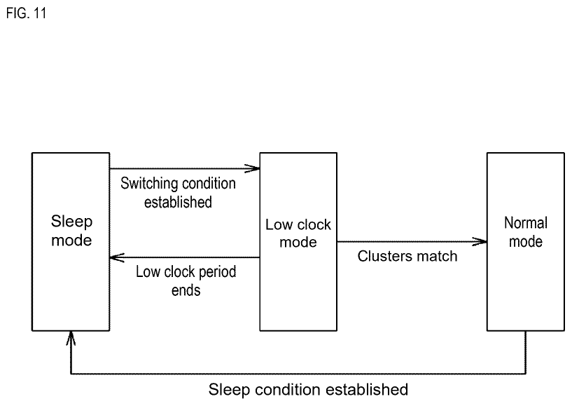

Due to functions of the ECU 400 such as described above, the operating mode of the ECU 400 transitions between the sleep mode, the low clock mode, and the normal mode. FIG. 11 is a state transition diagram for describing switching of the operating mode of an ECU according to the embodiment. When, in the sleep mode, a switching condition is established, the operating mode of the ECU 400 switches to the low clock mode.

When, in the low clock mode, the cluster to which the ECU 400 belongs is designated as the wakeup target in the NM frame, that is, the cluster designated as the wakeup target in the NM frame matches the cluster to which the ECU 400 belongs, the operating mode of the ECU 400 switches to the normal mode.

When, in the low clock mode, the low clock period ends without a frame being received, the operating mode of the ECU 400 switches to the sleep mode.

When, in the normal mode, a sleep condition is established, the operating mode of the ECU 400 switches to the sleep mode.

### Operations of Ecus

Hereinafter, the operations of an ECU having a non-supporting I/F according to the present embodiment will be described. Here, the operations of the ECU 400 will be representatively described, but the integrated ECU 200 also performs similar operations.

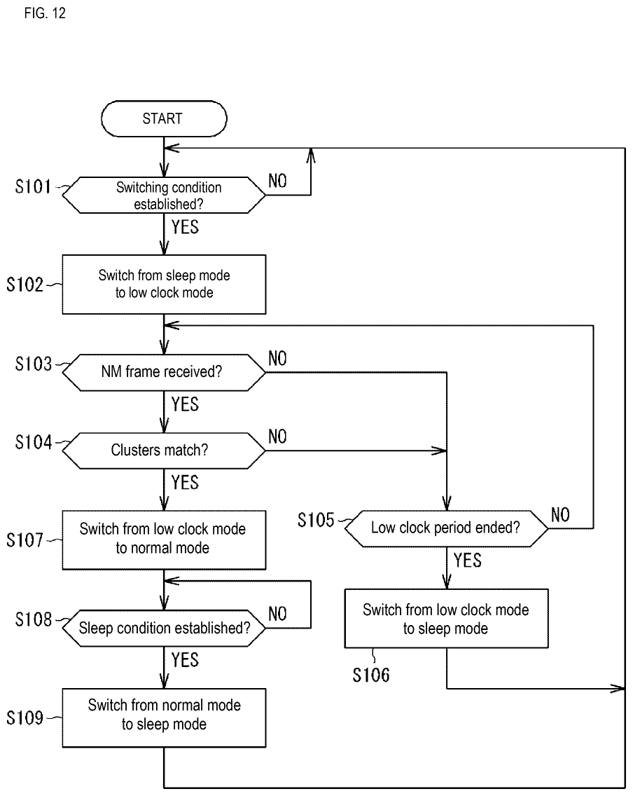

FIG. 12 is a flowchart illustrating an example of the operations of an ECU according to the present embodiment.

If the ECU 400 is in the sleep mode, the control circuit 411 determines whether a switching condition is established (step S101). If a switching condition is not established (NO in step S101), the control circuit 411 executes step S101 again.

If a switching condition is established (YES in step S101), the control circuit 411 interrupts the processor 401 and instructs the processor 401 to switch to the low clock mode (step S102). The processor 401 starts up due to the interrupt signal, and the operating mode of the ECU 400 switches from the sleep mode to the low clock mode.

The processor 401 determines whether an NM frame has been received (step S103). If an NM frame has not been received (NO in step S103), the processor 401 proceeds to step S105.

If the ECU 400 receives an NM frame (YES in step S103), the processor 401 determines whether the cluster designated as the wakeup target in the NM frame matches the cluster to which the ECU 400 belongs (step S104).

If the cluster designated as the wakeup target in the NM frame does not match the cluster to which the ECU 400 belongs (NO in step S104), the processor 401 proceeds to step S105 and determines whether the low clock period has ended (step S105).

If the low clock period has not ended (NO in step S105), the processor 401 returns to step S103.

If the low clock period has ended (YES in step S105), the processor 401 switches the operating mode of the ECU 400 from the low clock mode to the sleep mode (step S106). When the operating mode switches to the sleep mode, the processor 401 returns to step S101.

If the cluster designated as the wakeup target in the NM frame matches the cluster to which the ECU 400 belongs (YES in step S104), the processor 401 switches the operating mode of the ECU 400 from the low clock mode to the normal mode (step S107).

In the normal mode, the processor 401 determines whether a sleep condition is established (step S108). If a sleep condition is not established (NO in step S108), the processor 401 executes step S108 again.

If a sleep condition is established (YES in step S108), the processor 401 switches the operating mode of the ECU 400 from the normal mode to the sleep mode (step S109). When the operating mode switches to the sleep mode, the processor 401 returns to step S101.

### Variations

The low clock mode described in the above embodiment is an example of the “low power consumption mode”. In other words, the low power consumption mode is not limited to the low clock mode. For example, the low power consumption mode may be a mode in which the communication I/F 410 is operating and the peripheral circuit stops operating but the processor 401 is operating at the same clock frequency as in the normal mode. Even in such an operating mode, the peripheral circuit has stopped operating, and thus power consumption can be reduced to lower than in the normal mode. In another example, the low power consumption mode may be a mode in which the communication I/F 410 is operating and the operation clock frequency of the processor 401 is lower than in the normal mode but the peripheral circuit is operating. Even in such an operating mode, the operation clock frequency of the processor 401 is low, and thus power consumption can be reduced to lower than in the normal mode.

### Appendix

The embodiments disclosed herein are to be considered in all respects as exemplary and not restrictive. The scope of rights of the present disclosure is indicated by the claims, rather than by the aforementioned embodiments, and all changes that come within the meaning and range of equivalency of the claims are intended to be embraced therein. The following listing of claims will replace all prior versions and listings of claims in the application.

1. An in-vehicle device for controlling a control target, comprising:
a communication interface that is connected to a communication line and does not have a determination function for determining whether designation information designating the in-vehicle device as a startup target is included in a frame received through the communication line by the communication interface;
a first determination unit configured to determine whether a switching condition for switching an operating mode of the in-vehicle device from a sleep mode in which a processor stops operating and control of the control target is not executable to a low power consumption mode in which the processor operates at a predetermined clock frequency and power consumption in the in-vehicle device is higher than in the sleep mode is established;
a first switching unit configured to, if it is determined by the first determination unit that the switching condition is established, switch the operating mode from the sleep mode to the low power consumption mode;
a second determination unit configured to determine whether designation information designating the in-vehicle device as a startup target is included in a frame received through the communication line by the communication interface, while the operating mode is the low power consumption mode; and
a second switching unit configured to, if it is determined by the second determination unit that the designation information is included in the received frame, switch the operating mode from the low power consumption mode to a normal mode in which the processor operates at a higher clock frequency than the predetermined clock frequency, power consumption in the in-vehicle device is higher than in the low power consumption mode and control of the control target is executable.

2. The in-vehicle device according to claim 1, further including;
a third switching unit configured to, if a set period elapses without the communication interface receiving a frame through the communication line, while the operating mode is the low power consumption mode, switch the operating mode from the low power consumption mode to the sleep mode.

3. The in-vehicle device according to claim 2, wherein the set period is set according to a cluster to which the in-vehicle device belongs.

4. The in-vehicle device according to claim 2, wherein the set period is set according to a state of a vehicle in which the in-vehicle device is installed.

5. The in-vehicle device according to claim 2, wherein the set period is set according to a service that the in-vehicle device provides to a user.

6. The in-vehicle apparatus according to claim 1, wherein the switching condition is that the communication interface receives a signal.

7. The in-vehicle apparatus according to claim 1, wherein the switching condition is that a preset execution period of the sleep mode ends.

8. The in-vehicle device according to claim 7, wherein the execution period of the sleep mode is set according to a cluster to which the in-vehicle device belongs.

9. The in-vehicle device according to claim 7, wherein the execution period of the sleep mode is set according to a state of a vehicle in which the in-vehicle device is installed.

10. The in-vehicle device according to claim 7, wherein the execution period of the sleep mode is set according to a service that the in-vehicle device provided to a user.

11. The in-vehicle device according to 1, wherein the low power consumption mode is an operating mode in which control of the control target is not executable.

12. The in-vehicle device according to 1, wherein the sleep mode is an operating mode in which processing of a frame received through the communication line is not executable, and the low power consumption mode is an operating mode in which processing of a frame received through the communication line is executable.

13. (canceled)

14. The in-vehicle device according to claim 1,
wherein the low power consumption mode is an operating mode in which transmission of a frame by the communication interface is not executable, and
the normal mode is an operating mode in which transmission of a frame by the communication interface is executable.

15. An in-vehicle system comprising:
the in-vehicle device according to claim 1;
the communication line; and
an in-vehicle control device connected to the communication line and configured to output the frame to the communication line.

16. A control method for use by an in-vehicle device that controls a control target, the control method comprising:
a step of determining whether a switching condition for switching an operating mode of the in-vehicle device from a sleep mode in which a processor stops operating and control of the control target is not executable to a low power consumption mode in which the processor operates at a predetermined clock frequency and power consumption in the in-vehicle device is higher than in the sleep mode is established;
a step of, if it is determined that the switching condition is established, switching the operating mode from the sleep mode to the low power consumption mode;
a step of determining whether designation information designating the in-vehicle device as a startup target is included in a frame received through a communication line by a communication interface that does not have a determination function for determining whether the designation information designating the in-vehicle device as a startup target is included in the received frame, while the operating mode is the low power consumption mode; and
a step of, if it is determined that the designation information is included in the received frame, switching the operating mode from the low power consumption mode to a normal mode in which the processor operates at a higher clock frequency than the predetermined clock frequency, power consumption in the in-vehicle device is higher than in the low power consumption mode and control of the control target is executable.

17. A control program for use by an in-vehicle device that controls a control target, the control program causing a computer to execute:
a step of determining whether a switching condition for switching an operating mode of the in-vehicle device from a sleep mode in which a processor stops operating and control of the control target is not executable to a low power consumption mode in which the processor operates at a predetermined clock frequency and power consumption in the in-vehicle device is higher than in the sleep mode is established;
a step of, if it is determined that the switching condition is established, switching the operating mode from the sleep mode to the low power consumption mode;
a step of determining whether designation information designating the in-vehicle device as a startup target is included in a frame received through a communication line by a communication interface that does not have a determination function for determining whether the designation information designating the in-vehicle device as a startup target is included in the received frame, while the operating mode is the low power consumption mode; and
a step of, if it is determined that the designation information is included in the received frame, switching the operating mode from the low power consumption mode to a normal mode in which the processor operates at a higher clock frequency than the predetermined clock frequency, power consumption in the in-vehicle device is higher than in the low power consumption mode and control of the control target is executable.
